(19) United States
(12) Patent Application Publication
(10) Pub. No.: US 2024/0355038 A1
(43) Pub. Date: Oct. 24, 2024

(54) OCCUPANCY GRIDS FOR NEURAL RADIANCE FIELDS

(71) Applicant: Intel Corporation, Santa Clara, CA (US)

(72) Inventors: Alexey M. Supikov, Santa Clara, CA (US); Ronald Tadao Azuma, San Jose, CA (US)

(21) Appl. No.: 18/758,162

(22) Filed: Jun. 28, 2024

Related U.S. Application Data
(60) Provisional application No. 63/632,366, filed on Apr. 10, 2024.

(51) Int. Cl. G06T 15/06; G06T 7/557; G06T 15/50

(52) U.S. Cl. CPC G06T 15/06; G06T 7/557; G06T 15/503; G06T 2207/20081; G06T 2207/20084; G06T 2210/56

(57) ABSTRACT

Example apparatus disclosed herein query a neural network for an optical density at a sample point along a training ray, the training ray associated with training the neural network to provide a neural representation of a video frame. Disclosed example apparatus also generate an occupancy grid for the video frame based on the optical density at the sample point along the training ray, the occupancy grid including voxels to indicate whether respective portions of a three-dimensional (3D) volume associated with the neural representation are occupied with geometry.

### RELATED APPLICATION(S)

This patent claims the benefit of U.S. Provisional Patent Application No. 63/632,366, which was filed on Apr. 10, 2024. U.S. Provisional Patent Application No. 63/632,366 is hereby incorporated herein by reference in its entirety. Priority to U.S. Provisional Patent Application No. 63/632,366 is hereby claimed.

### BACKGROUND

Machine learning models, such as neural networks, multi-layer perceptrons, etc., can be configured to implement a neural representation of a three-dimensional (3D) scene based on a set of two-dimensional (2D) images of the scene associated with a set of reference viewpoints. The neural representation, also referred to as a neural radiance field, is trained to encode structural and color information that can be used to render a 2D image of the scene from viewpoints that may be different from the reference viewpoints. A sequence of neural representations, or neural radiance fields, can also be trained to render respective video frames of a video of a 3D scene. As such, the sequence of neural representations, or neural radiance fields, form a neural video of the scene that can be rendered from different viewpoints and, thus, provide an immersive video experience.

### BRIEF DESCRIPTION OF THE DRAWINGS

FIGS. 1A-1B illustrate details of an example neural network that implements an example neural representation of a scene.

FIG. 2 illustrates an example implementation of the neural network of FIGS. 1A-1B that corresponds to an example multi-layer perceptron (MLP).

FIG. 3 illustrates an example neural representation training circuit to train the example neural network of FIG. 2 based on occupancy grids in accordance with teachings of this disclosure.

FIGS. 4-6 illustrate example operation of the neural representation training circuit of FIG. 3 to construct an occupancy gird for the example neural network of FIG. 2.

FIGS. 7 and 8A-8B are flowcharts representative of example machine readable instructions and/or example operations that may be executed, instantiated, and/or performed by example programmable circuitry to implement the neural representation training circuit of FIG. 3.

FIG. 9 is a block diagram of an example processing platform including programmable circuitry structured to execute, instantiate, and/or perform the example machine readable instructions and/or perform the example operations of FIGS. 7 and 8A-8B to implement the neural representation training circuit of FIG. 3.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 7 and 8A-8B) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Images, audio, video, 3D objects, and most media, are typically captured and represented by discrete samples. For example, an image is typically represented as a grid of discrete samples, such as an array of pixels, where each pixel has numbers representing the intensity at that image location in red, green, and blue. In contrast, a neural representation is a neural network that stores content, such as an image, in the weights and structure of the neural network. Neural representations are becoming ubiquitous in visual computing because they offer advantages in compactness and continuous representations. In particular, they enable a new way to represent and render photorealistic depictions of a real scene, given several photos of that scene, by enabling joint reconstruction and encoding of three-dimensional (3D) scene complex geometry and radiance distribution from a set of two-dimensional (2D) color images taken from different viewpoints. For example, such a neural network may receive (x, y, z) coordinates as input and output (R, G, B) pixel values that represent a color distribution in 3D space.

Neural Radiance Fields (NeRFs) are a specific neural representation that trains a neural network (e.g., a multilayer perceptron (MLP)) to represent the appearance of a 3D scene. A NeRF takes as input several images of a static scene, where the cameras are at known locations, and uses deep learning techniques to train the neural network to implement a neural representation of that scene. Rendering an image from a NeRF is done through volume rendering, which involves repeated queries of the neural network to determine color and opacity at many points along rays passing through an input pixel locations, such as input (x, y) coordinates.

Using large a multi-level perceptron (MLP) as its main neural network, the original NeRF algorithm is slow due to a large number of MLP queries produced by sampling along many rays. Some techniques to improve NeRF performance include employing sample pruning to eliminate queries for samples along the rays that hit empty or occluded regions. Being able to eliminate queries early through sample pruning is an important technique for achieving good NeRF rendering performance.

Some techniques that prune spatial queries in empty space or occluded regions are based on storing occupancy information in spatial data structures. Such pruning techniques involve voxelizing a volume of interest (e.g., corresponding to the 3D scene to be represented by the NeRF) using regular grids and storing an explicit occupancy (e.g., density) value in each voxel. Pruning techniques use this occupancy grid to prune samples located in voxels with low occupancy. Prior pruning techniques update that occupancy information stored in the occupancy grid by querying the NeRF neural network during training to sample density in random locations and storing the maximum optical density values in the corresponding voxels of the occupancy grid. To gradually introduce empty space learned by the neural network, the stored density values are subject to exponential moving average (EMA) decay, which marks voxels as empty if density above some threshold was not observed by random sampling for a period of time.

However, such random occupancy sampling can miss fine details and lead to artifacts, as described in further detail value. Furthermore, this issue has a cumulative effect in the case of incremental training for video/dynamic data, referred to as incremental neural video (INV). INV is a NeRF-based technique that supports the creation and streaming of 3D video scenes based on incoming multi-view video streams. INV is based on training a NeRF incrementally by reusing MLP weights from a previous frame to train the neural network (e.g., MLP) for a new frame. However, in the case of prior occupancy grids based on random sampling of the volume interest, once marked as empty in the occupancy grid, a voxel's space is excluded from gradient propagation, and may never be updated. Thus, the details gradually disappear from frame to frame and no combination of hyperparameters can fix it.

Examples occupancy grid generation techniques disclosed herein provide a robust way to update occupancy grids for neural representations (e.g., NeRFs), enabling artifact-free, fast training and rendering of static scenes and incremental neural videos. Instead of relying on random sampling as in prior techniques, examples disclosed herein mark voxels of an occupancy grid as occupied by using density data from training ray marching, since training rays will hit geometry if it is present. Also, instead of storing the maximum detected density in the occupancy grid voxels, at least some disclosed example occupancy grid generation techniques store a fixed, pre-defined number when optical density is detected at a voxel location, thus avoiding the need for atomic operations when performing parallel updates. To enable a neural network to adapt to geometry changes in 3D video sequences, at least some disclosed examples delay occupancy grid tests and EMA decay operations in the beginning of training for a new frame.

Examples disclosed herein fix the flaw of at least some prior sampling-based pruning techniques for neural radiance fields and enable fast rendering and training of artifact-free neural representations. In addition, disclosed examples are applicable to neural videos and are efficiently supported on hardware (e.g., such as discrete GPUs, integrated GPUs, future generation NPUs, etc.).

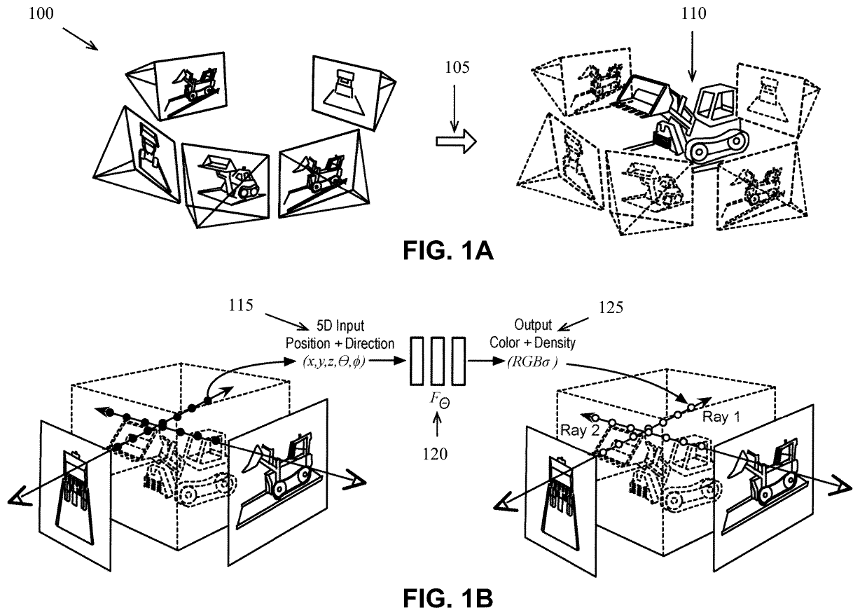

FIGS. 1A-1B illustrate details of an example NeRF neural network. FIG. 1A shows conceptual diagrams of training a NeRF. FIG. 1B shows input and output details of a NeRF neural network. As shown in FIG. 1A, several images 100 may be taken of a three-dimensional scene from known locations. A training operation 105 can be performed to build a neural representation of that three-dimensional (3D) scene from those images. The trained neural representation is a NeRF that represents the scene via the weights of the neural network model. The NeRF can be used to render the scene 110 from viewpoints other than the viewpoints of the input images. As shown in FIG. 1B, a trained NeRF can receive a five-dimensional (5D) input 115 that includes a 3D position (x, y, z) and a 2D direction (θ and Φ). The NeRF can be a neural network 120 (F₀), such as an MLP, that is trained to produce an output 125 color value (R,G,B) and density σ in response to the 5D input 115. Volume rendering techniques can repeatedly access the neural network 120 to render the 3D scene from an arbitrary viewpoint to accumulate colors and densities into a 2D image.

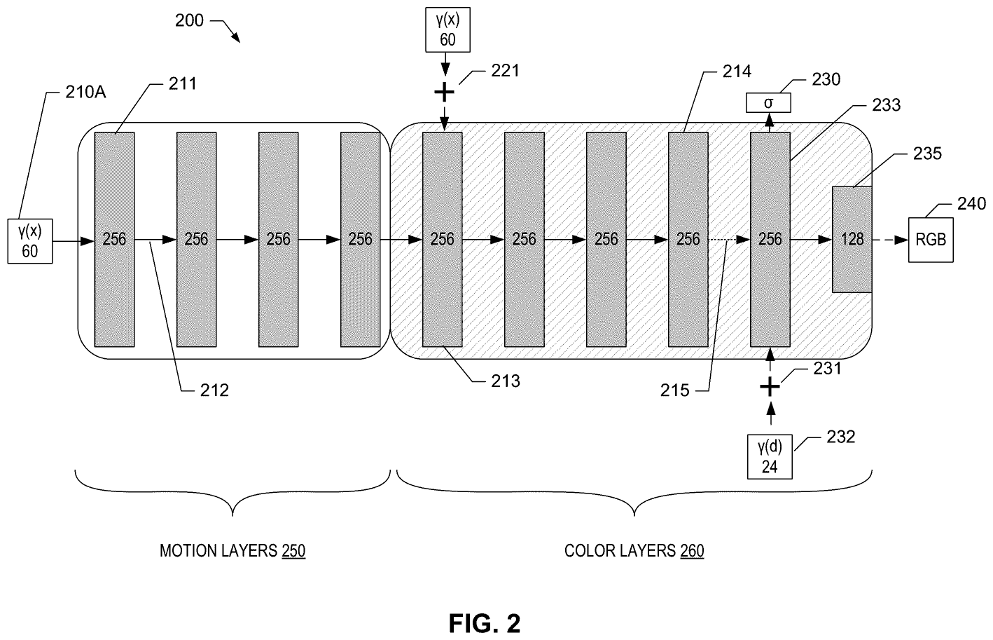

FIG. 2 illustrates an example neural network 200 that implements an MPL that can be trained to provide neural representations (e.g., NeRFs) of static 3D scenes, 3D videos (e.g., INVs), etc. The neural network 200 is an MLP, which is a fully connected neural network that is used for NeRF implementations. The neural network 200 of the illustrated example includes multiple fully connected layers 211, each with 256 channels and an example rectified liner unit (ReLU) activation function 212. An example positional input 210A (γ(x), e.g., 3D-position (x, y, z) is provided at the first fully connected layer 211 and propagates through eight fully connected layers. An additional instance of the positional input 210B is provided via a skip connection to an example fifth fully connected layer 213. The positional input 210B is combined with the fifth fully connected layer 213 via vector concatenation using an example combining function 221. An example eighth fully connected layer 214 outputs a first example output layer 233, which outputs an example volume density 230 for the position γ(x) and a 256-dimension feature vector. The 256-dimension feature vector is concatenated via an example combining function 231 with an example viewing direction 232 (γ(d), e.g., 2D) direction (θ, Φ) and processed via a second example output layer 235 to generate an example RGB value 240 for the position γ(x) when viewed from direction γ(d). Instead of using positions x and direction d inputs directly, the neural network 200 applies an encoding function γ to convert 3 position coordinates x to multichannel inputs with 60 channels for position, and to convert 2 direction coordinates d to 24 channels for direction, for example. The use of encoding function can improve the ability of the neural network to represent high frequencies. Examples of the encoding function γ include frequency encoding, Fourier features, multi-resolution hash tables, etc.

The neural network 200 enables the synthesis of new images of a 3D scene as seen from a desired viewpoint at a specific time, even if that viewpoint was not directly captured by a video camera. The neural network 200 also supports INV. As described above, the INV approach takes as input multiple video streams with camera parameters (e.g., intrinsic and/or extrinsic parameters) for each stream, where each stream captures the same scene from a different viewpoint. INV maintains a NeRF-like MLP, such as the neural network 200, that is up to date with the current timestamp of the video streams. The NeRF-like MLP 200 is incrementally updated for each incoming time frame (corresponding to multiple views in space). Incremental training uses MLP weights from the previous frame to train the MLP 200 for the next frame. Therefore, the MLP 200 can automatically re-use learning from previous frames and adjusts the MPL layer weights for a new frame. In this frame-to-frame incremental training mode, the MLP weights exhibit the following behavior: the front layers change from frame to frame, whereas the back layers change slowly or remain unchanged. Such behavior happens spontaneously in the INV NeRF MPL 200. As described above, experiments have shown that the front layers 250 of the MPL 200 are mainly responsible for encoding motion/deformation, whereas the back layers 260 mainly encode color of the 3D scene fragments.

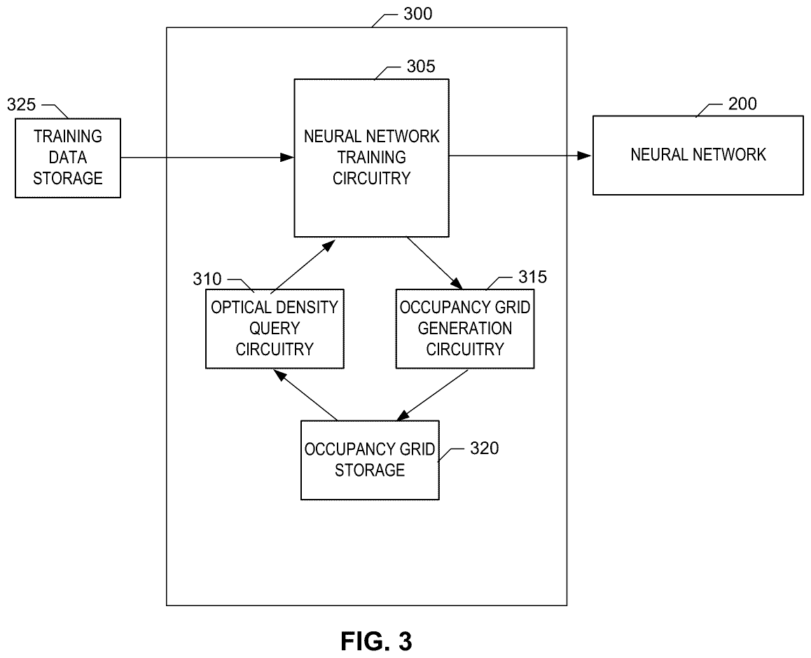

FIG. 3 is a block diagram of an example neural representation training circuit 300 to train the neural network 200 of FIG. 3 and generate occupancy grid(s) for the neural network 200 in accordance with teachings of this disclosure. The neural representation training circuit 300 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the neural representation training circuit 300 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example neural representation training circuit 300 includes example neural network training circuitry 305, example optical density query circuitry 310, example occupancy grid generation circuitry 315, and example occupancy grid storage 320. The neural network training circuitry 305 implements any appropriate neural network training technique or combination of techniques to train the layer weights of the neural network 200 to implement a neural representation of a 3D scene based on the training data stored in example training data storage 325. In the illustrated example, the training data storage 325 can be implemented by any number and/or types of storage devices, memories, etc., and stores training data including multiple images captured from different viewpoints of a 3D scene (also referred to herein as multi-view images), multiple video streams from different viewpoints of the 3D scene (also referred to herein as multi-view video streams), etc. For example, the neural network training circuitry 305 can implement forward propagation techniques, backward propagation techniques, etc., or any combination thereof, to incrementally train the neural network 200 based on the multi-view video streams stored in the training data storage 325 to implement an INV that outputs a stream of NeRFs that enable video frames to be rendered from viewpoints other than the viewpoints of the input multi-view video streams. Further example training techniques that can implemented by the neural network training circuitry 305 are described in U.S. Patent Publication No. 2024/0135483, which is titled “INCREMENTAL NEURAL REPRESENTATION FOR FAST GENERATION OF DYNAMIC FREE-VIEWPOINT VIDEOS,” and which was published on Apr. 25, 2024.

In the illustrated example of FIG, 3, the neural network 200 implements a NeRF, which is a technique for representing geometry and directional lighting information of a 3D scene. It is based on a positional neural representation (e.g., a combination of grids, hash grids and neural networks, such as an MLP) that takes 3D position of a point and a direction vector as input and produces optical density (e.g., opaqueness) at that point and radiance leaving the point at the given direction. The resulting representation is compact and expressive, enabling photorealistic depictions of highly detailed 3D scenes. NeRFs can also be generalized to other types of geometrical and non-geometrical data, such as signed distance functions, electromagnetic fields, etc.

Once trained by the neural network training circuitry 305, the neural network 200 can render images of a 3D scene from an arbitrary viewpoint using volume rendering via ray marching. Ray marching involves casting rays for every image pixel, sampling the neural network at the points along the ray and accumulating transparency and weighted radiance to produce a final pixel color.

The neural network training circuitry 305 trains the neural network 200 to implement a neural representation a NeRF that fits 3D scene data from images taken from different viewpoints with reference (e.g., known) camera parameters. Such training views are used by the neural network training circuitry 305 to generate training rays. During training, the neural network training circuitry 305 invokes the neural network 200 to perform volume rendering using training rays to generate pixel colors that are compared against ground truth pixel colors in the training data. The neural network training circuitry 305 uses the color difference in a loss function to adjust the weights of the neural network 200.

Volume rendering involves querying the underlying neural network 200 at multiple points along a ray. Millions of rays may be used during training and rendering, resulting in hundreds of millions of network queries. To address the computational complexity, some volume rendering techniques have focused on making each query cheaper (e.g., by simplifying the underlying MLPs) and/or reducing the number of queries by skipping sampling points that hit empty space.

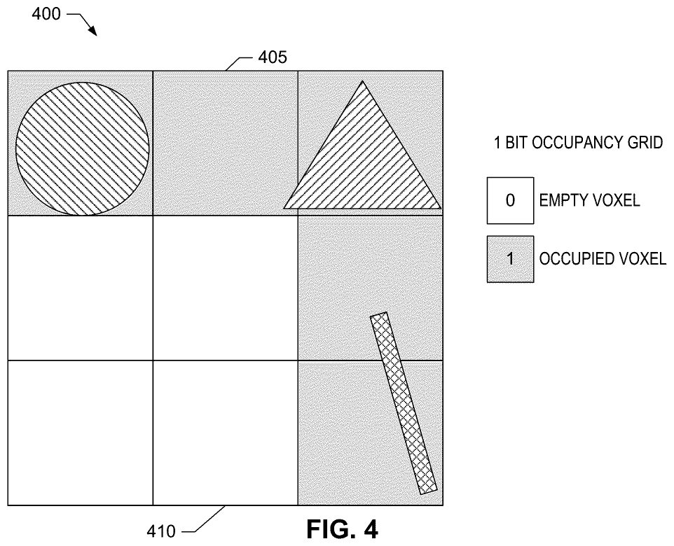

Techniques that reduce the number of queries by skipping sampling points that hit empty space have proven to be efficient, enabling the removal of 75%-80% of samples early in the pipeline in some instances. Such sample pruning relies on a way to tell if the space at a given 3D location is empty or occupied without performing a full network query. Some such pruning techniques use a regular 3D grid, referred to as an occupancy grid, as a helper structure that stores floating-point values indicating if grid voxels are occupied. An example occupancy grid 400 is illustrated in FIG. 4.

The example occupancy grid 400 of FIG. 4 includes voxels, such as the example voxels 405 and 410, that represent respective 3D portions (e.g., regions) of a 3D volume corresponding to a 3D scene to be represented by the neural representation (e.g., NeRF) implemented by the neural network 200. Prior occupancy grid techniques store approximate maximum density of the geometry in each voxel. During ray marching, the samples along the ray are tested against that grid to determine if they hit a voxel with density below threshold, which is representative of an empty voxel and, if so, those samples are skipped accordingly. In some examples, the voxels of the occupancy grid 400 are also associated with respective occupancy flags, which may be 1-bit values that are asserted or de-asserted to indicate whether the corresponding voxel is occupied by geometry or not. In the example of FIG. 4, shaded voxels of the occupancy grid 400, such as the voxel 405, have asserted occupancy flags (e.g., set to a logic-1) to indicate those voxels are associated with space occupied by geometry, whereas unshaded voxels of the occupancy grid 400, such as the voxel 410, have de-asserted occupancy flags (e.g., set to a logic-0) to indicate those voxels are associated with space that is not occupied by geometry

At the start of training, the neural network has no information about the 3D scene. Prior pruning techniques attempt to gradually fill the occupancy grid 400 with densities learned by the network at training time by periodically sampling density at random locations within each voxel and updating voxel occupancy values with the maximum between the current voxel value in the grid and the detected density at the sampled location in the voxel. Also, in some such maximum density occupancy grid techniques, at each update iteration, the density value for a given voxel is reduced by exponential moving average (EMA) decay, so that the occupancy grid value for a voxel for which samples with high density are not detected for a long time will fall below a threshold indicating an empty voxel. In some maximum density occupancy grid techniques, before ray marching is performed, the maximum density occupancy grid 400 is converted into a 1 bit voxel grid that encodes if a given voxel is empty or not.

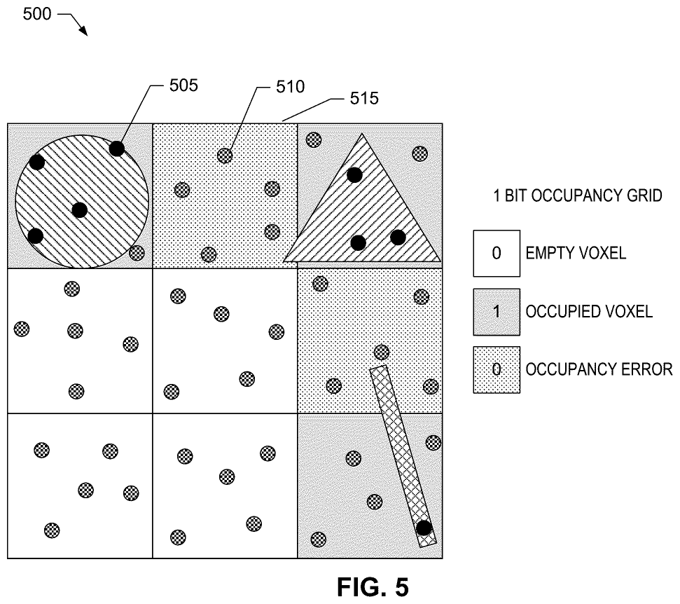

Although fast and able to prune up to 80% of samples, such prior occupancy grid techniques result in artifacts. FIG. 5 illustrates the root cause of this flaw, namely, that random sampling is used to test density inside the voxels. FIG. 5 illustrates an example occupancy grid 500 in which random sampling is used to update the grid voxels. The dots in FIG. 5, such as the example dot 505, represent sample points selected based on random sampling. For samples that correspond to geometry, such as the sample 505, the neural network 200 will return relatively high optical densities, whereas for samples that correspond to empty space, such as the sample 510, the neural network 200 will return relatively low optical densities. Voxels having sample points with high optical density (e.g., exceeding a threshold) will be considered occupied, whereas voxels having sample points with low optical density (e.g., not exceeding the threshold) will be considered empty. As shown by the example of FIG. 5, random sampling may miss small geometrical details and erroneously declare a voxel empty, such as the example voxel 515. Furthermore, once a voxel is declared empty, all samples hitting that voxel are excluded from optimization during training, so the network will never have a chance to recover those details.

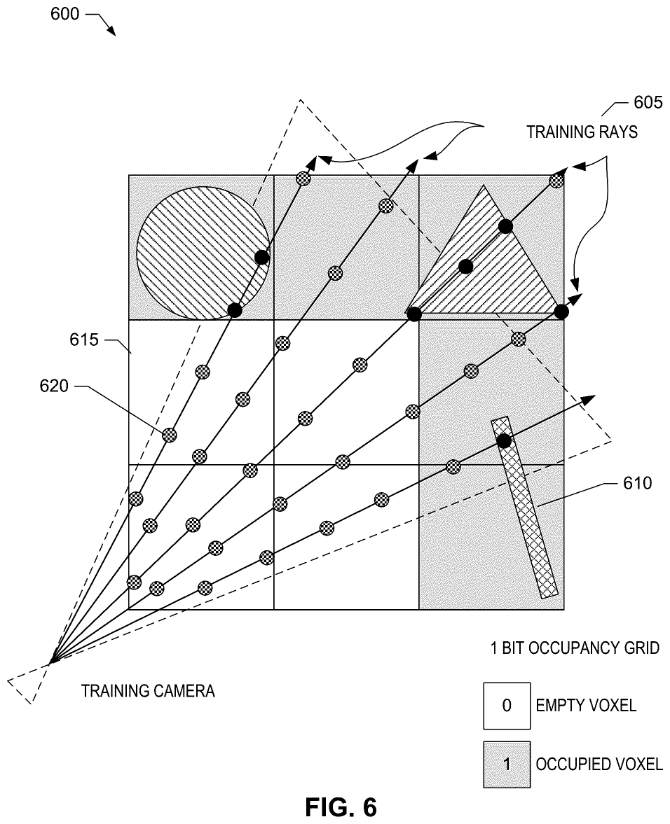

Instead of fully relying on random sampling of 3D space, disclosed example occupancy grid techniques implemented by the neural representation training circuit 300 fill occupancy grids using density values computed during training in the density probing ray marching pre-pass. An example operation of a disclosed occupancy grid technique implemented by the neural representation training circuit 300 is illustrated in FIG. 6.

FIG. 6 illustrates an example occupancy grid 600 generated by the neural representation training circuit 300 and, in particular, by the optical density query circuitry 310, the occupancy grid generation circuitry 315, and the occupancy grid storage 320 of the neural representation training circuit 300. FIG. 6 also illustrates example training rays 605 used by the neural representation training circuit 300 to train the neural network 200. Generation of the occupancy grid 600 by the neural representation training circuit 300 is based on the following considerations. First, if geometry, such as the example geometry 610, is visible in the training images used by the neural network training circuitry 305 to train the neural network 200, then the training rays 605 will hit the geometry, and the optical density query circuitry 310 and the occupancy grid generation circuitry 315 can reliably detect the existence of such geometry and update voxels of the occupancy grid 600, such as the voxel 615, based on optical densities returned by the neural network for sample points along the training rays, such as the sample point 620. Second, if a light-weight density query pre-pass to get early stop distance and prune empty space missed by occupancy grids is implemented by the neural network training circuitry 305, the optical density query circuitry 310 and the occupancy grid generation circuitry 315 can re-use the density samples from this pass to update the voxels of the occupancy grid 600.

The following description provides additional implementation details for the example occupancy grid techniques disclosed herein and expand the occupancy grids to use with neural videos.

Occupancy initialization. During training, at the beginning of each video frame, the occupancy grid generation circuitry 315 resets each voxel of the occupancy grid 600 to a pre-defined value (e.g., represented herein by the variable Dhigh), which initializes the voxel as occupied. The occupancy grid generation circuitry 315 stores the reset occupancy grid 600 for the current frame of training in the occupancy grid storage 320. In some examples, the occupancy grid generation circuitry 315 also maintains respective occupancy flags for the voxels of occupancy grid, which can be stored as a separate 1-bit empty space indicator grid in the occupancy grid storage 320. The occupancy grid storage 320 can be implemented by any number and/or types of memories, storage devices, etc.

Occupancy usage and EMA decay delay for training incremental neural videos (INVs). For every new frame of an INV, the neural network training circuitry 305 begins training of the neural network for the current video frame by reusing the weights of the neural network 200 trained for the previous frame. It is possible that in the new frame some empty space will become occupied by a moving object, and some occupied space will be vacated. In at least some examples, to make sure that the neural network 200 learns these updates, the optical density query circuitry 310 and the occupancy grid generation circuitry 315 may postpone occupancy EMA decay and any sample pruning for a portion (e.g., ¼ or some other portion) of the first training epoch for the current frame.

Ray sampling. To guarantee maximum coverage of training data in the beginning of each epoch, in at least some disclosed examples, the neural network training circuitry 305 generates a random permutation of all training ray indices and obtains ray batches from that permutation.

Occupancy EMA decay with optional random sampling update. Every n-th training iteration, the occupancy grid generation circuitry 315 uses the EMA decay step to carve out empty space. Optionally, the optical density query circuitry 310 and the occupancy grid generation circuitry 315 may also perform random occupancy sampling with maximum density value capped at Dhigh, thereby avoiding decay being stuck at very high-density values. In some examples, at every n-th training iteration, the occupancy grid generation circuitry 315 updates the occupancy flags for the voxels of the occupancy grid 600, and may store the updated flags as a 1-bit empty space indicator grid in the occupancy grid storage 320.

Occupancy update. In at least some examples, at each training iteration, the optical density query circuitry 310 performs a density-only ray marching pre-pass operation that separates the current ray batch into sample points and filters the sample points using current occupancy grid 600 (e.g., by discarding the sample points associated with voxels that are empty as indicated by their occupancy flags). The optical density query circuitry 310 then uses the remaining pruned sample points to query the neural network 200 for optical densities at those sample points. The occupancy grid generation circuitry 315 evaluates the returned optical densities and removes low-density samples, then occluded samples are removed. The resulting set of high-density sample points are used by the occupancy grid generation circuitry 315 to update the corresponding voxels of the occupancy grid 600. For example, for each high-density sample point, the occupancy grid generation circuitry 315 writes the value Dhigh to the voxel where the sample is located, and discards the previous voxel value. That way, each voxel containing contributing geometry will be equally marked as occupied in the occupancy grid 600 regardless of the size of the contribution, resulting in a robust update. Additionally, since the same Dhigh value is written to the occupied voxels and replaces previously stored values, this update approach does not rely on atomic operations or any ordering of memory writes.

In view of the foregoing, in some examples, during training of the neural network 200 by the neural network training circuitry 305, the optical density query circuitry 310 of the neural representation training circuit 300 queries the neural network for an optical density at a sample point 620 along a training ray 605. As described above, the training ray 605 is used by the neural network training circuitry 305 to train the neural network 200 to provide a neural representation of a video frame. In some such examples, the occupancy grid generation circuitry 315 of the neural representation training circuit 300 generates the occupancy grid 600 for the video frame based on the optical density at the sample point 620 along the training ray 605. As described above, the occupancy grid 600 includes voxels 615 to indicate whether respective portions of a 3D volume associated with the neural representation are occupied with geometry. In some examples, the neural network training circuitry 305 trains the neural network 200 based on the occupancy grid 600, the training rays 605, and training images corresponding respectively to different camera views associated with the video frame.

In some examples, to generate the occupancy grid, the occupancy grid generation circuitry 315 updates a first one of the voxels 615 based on the optical density at the sample point 620 along the training ray 605, with the first one of the voxels 615 corresponding to a portion of the 3D volume including the sample point 620. For example, the occupancy grid generation circuitry 315 may update the first one of the voxels 615 based on comparison of the optical density at the sample point 620 along the training ray 605 to a threshold.

In some examples, the training ray 605 is a first training ray, the sample point 620 is a first sample point, and the optical density query circuitry 310 queries the neural network 200 for optical densities at sample points 620 along multiple training rays 605 (e.g., which include the first sample point of the first training ray), with the training rays 605 being associated with a training iteration of the neural network 200 performed by the neural network training circuitry 305, and the training rays 605. In some such examples, the occupancy grid generation circuitry 315 identifies ones of the voxels 615 of the occupancy grid 600 associated with ones of the optical densities that satisfy a threshold, and sets values of those voxels to a same value (e.g., Dhigh).

In some examples, the voxels 615 of the occupancy grid 600 include values and flags, with the values of the voxels are based on optical densities associated with respective training ray sample points 620 included in the portions of the 3D volume associated respectively with the voxels, and the flags are set to indicate whether the portions of the 3D volume associated respectively with the voxels 615 are occupied with geometry. In some such examples, the occupancy grid generation circuitry 315 sets the flags of the voxels 615 based on comparisons of the values of the voxels 615 to a threshold. In some such examples, the occupancy grid generation circuitry 315 updates the values of the voxels 615 of the occupancy grid 600 in successive training iterations associated with the video frame based on a decay value and updated optical densities returned by the neural network 200 for updated sample points 620 of updated training rays 605 associated with the successive training iterations. In some such examples, the occupancy grid generation circuitry 315 updates the flags of the voxels 615 of the occupancy grid 600 at an interval corresponding to a number of training iterations (e.g., at every n-th training iteration).

In some examples, after the training iterations performed by the neural network training circuitry 305 to train the neural network 200 for a given frame are completed, the occupancy grid generation circuitry 315 stores the final occupancy grid 600 for the given frame in the occupancy grid storage 320. In some examples, the final occupancy grid 600 is output by the neural representation training circuit 300 with the trained parameters of the neural network 200 for the given frame to provide a neural representation (e.g., NeRF) of the given frame. For example, the neural representation training circuit 300 may store and/or transmit the neural representation (NeRF), including the occupancy grid 600, for use by a compute device (e.g., media device, computer, smartphone, tablet, etc.) to render the frame.

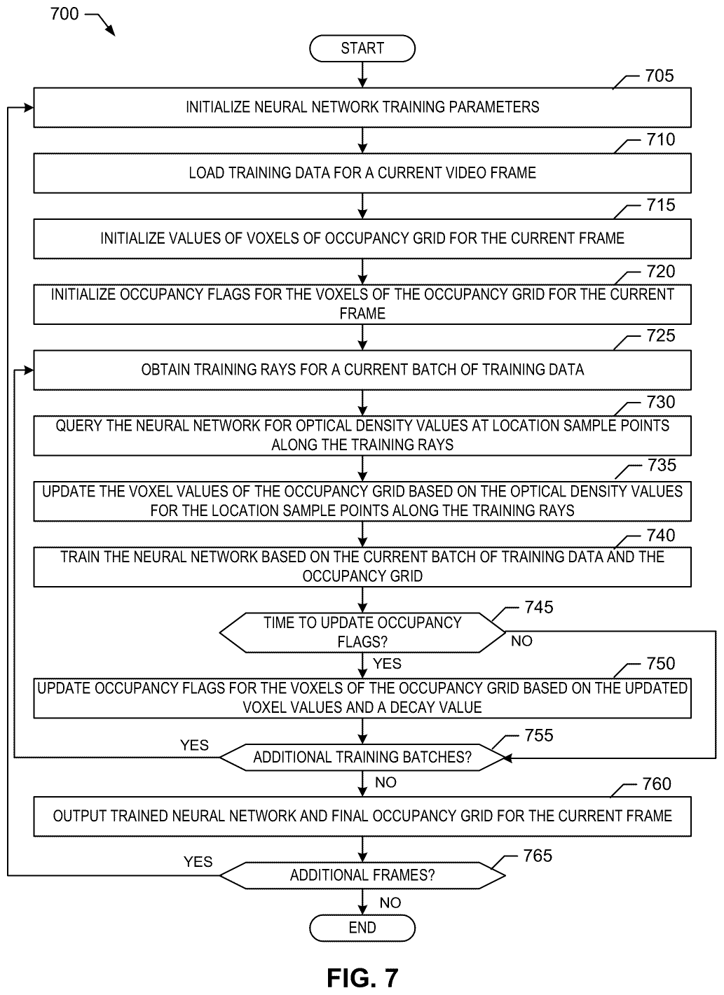

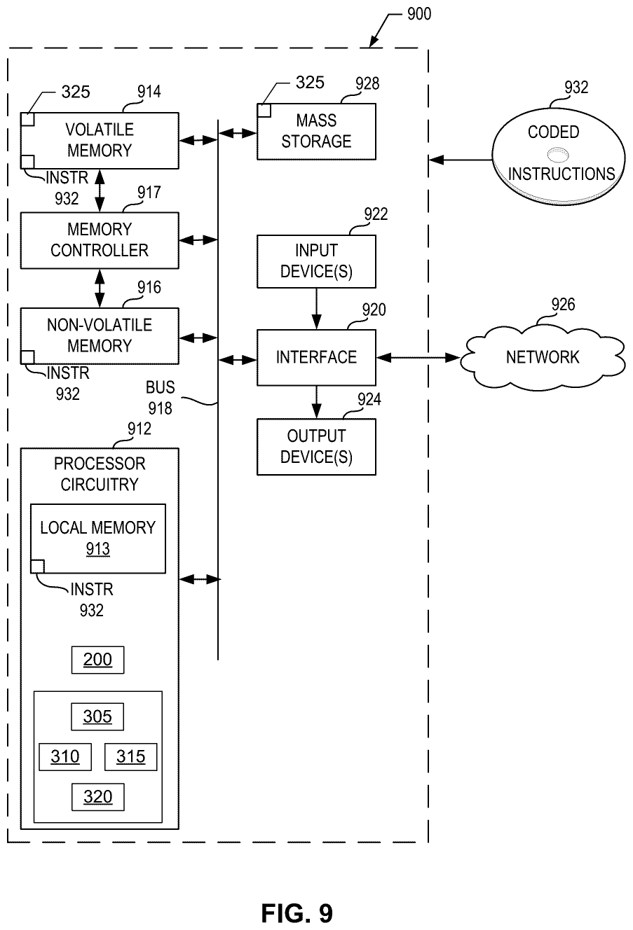

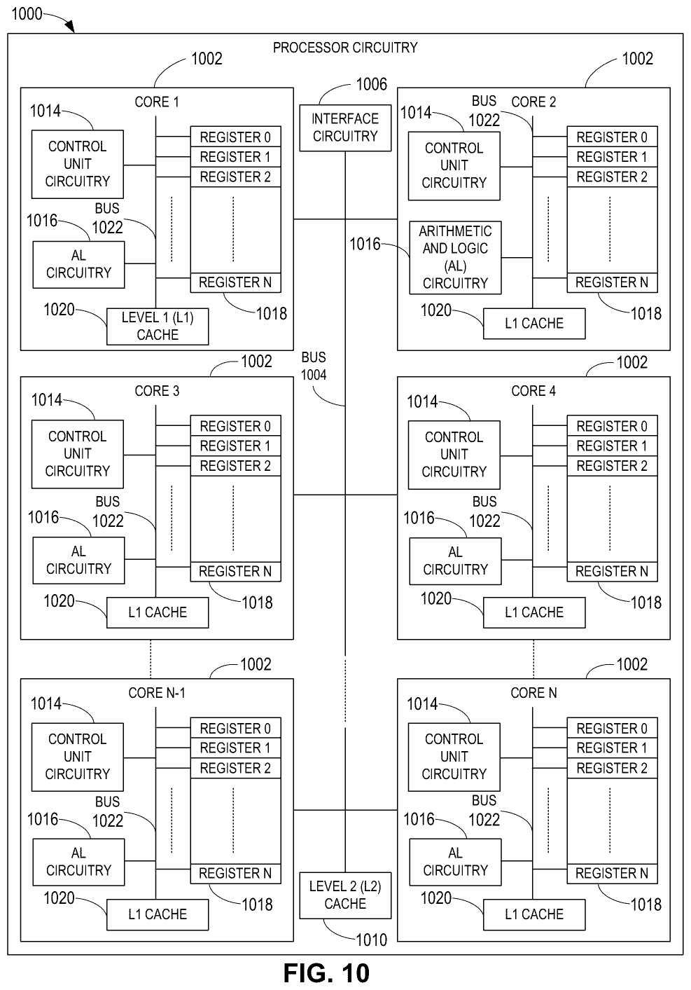

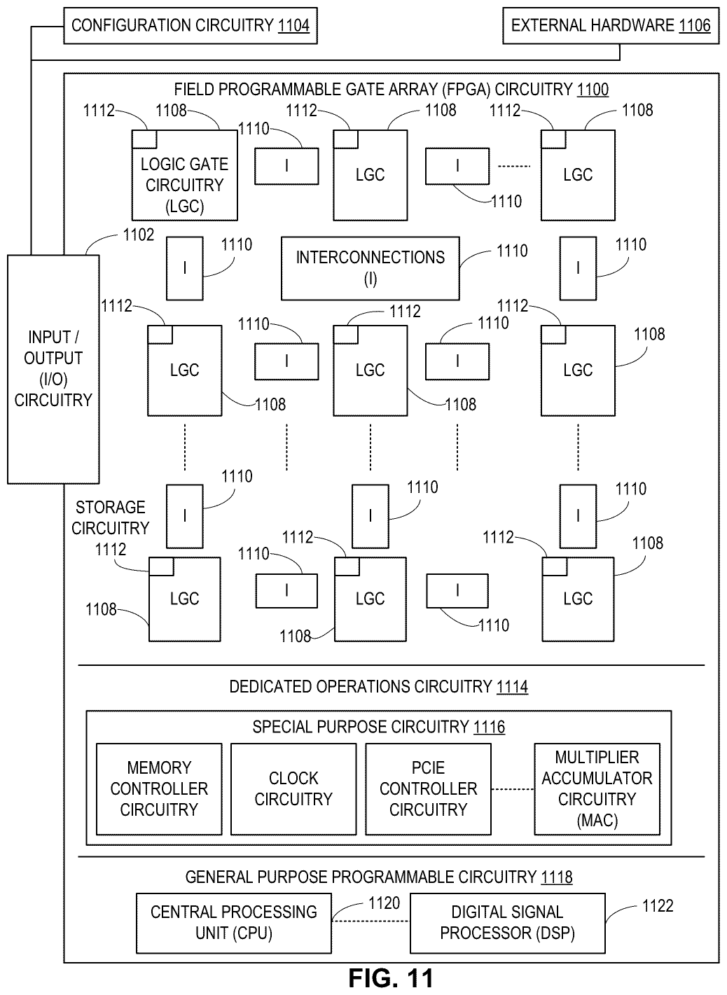

In some examples, the neural representation training circuit 300 includes means for training a neural network to provide a neural representation. For example, the means for training the neural network may be implemented by the neural network training circuitry 305. In some examples, the neural network training circuitry 305 may be instantiated by programmable circuitry such as the example programmable circuitry 912 of FIG. 9. For instance, the neural network training circuitry 305 may be instantiated by the example microprocessor 1000 of FIG. 10 executing machine executable instructions such as those implemented by at least blocks of FIGS. 7 and/or 8A-8B. In some examples, the neural network training circuitry 305 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the neural network training circuitry 305 may be instantiated by any other combination of hardware, software, and/or firmware. For example, the neural network training circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the neural representation training circuit 300 includes means for querying a neural network for optical density values. For example, the means for querying the neural network may be implemented by the optical density query circuitry 310. In some examples, the optical density query circuitry 310 may be instantiated by programmable circuitry such as the example programmable circuitry 912 of FIG. 9. For instance, the optical density query circuitry 310 may be instantiated by the example microprocessor 1000 of FIG. 10 executing machine executable instructions such as those implemented by at least blocks of FIGS. 7 and/or 8A-8B. In some examples, the optical density query circuitry 310 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the optical density query circuitry 310 may be instantiated by any other combination of hardware, software, and/or firmware. For example, the optical density query circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the neural representation training circuit 300 includes means for generating and/or updating an occupancy grid. For example, the means for generating and/or updating the occupancy grid may be implemented by the occupancy grid generation circuitry 315. In some examples, the occupancy grid generation circuitry 315 may be instantiated by programmable circuitry such as the example programmable circuitry 912 of FIG. 9. For instance, the occupancy grid generation circuitry 315 may be instantiated by the example microprocessor 1000 of FIG. 10 executing machine executable instructions such as those implemented by at least blocks of FIGS. 7 and/or 8A-8B. In some examples, the occupancy grid generation circuitry 315 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the occupancy grid generation circuitry 315 may be instantiated by any other combination of hardware, software, and/or firmware. For example, the occupancy grid generation circuitry 315 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the neural representation training circuit 300 is illustrated in FIG. 3, one or more of the elements, processes, and/or devices illustrated in FIG. 3 may be combined, divided, re-arranged, omitted, eliminated, and/or implemented in any other way. Further, the example neural network 200, the example neural network training circuitry 305, the example optical density query circuitry 310, the example occupancy grid generation circuitry 315, the example occupancy grid storage 320, and/or, more generally, the example neural representation training circuit 300 of FIG. 3, may be implemented by hardware alone or by hardware in combination with software and/or firmware. Thus, for example, any of the example neural network 200. the example neural network training circuitry 305, the example optical density query circuitry 310, the example occupancy grid generation circuitry 315, the example occupancy grid storage 320, and/or, more generally, the example neural representation training circuit 300, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example neural representation training circuit 300 may include one or more elements, processes, and/or devices in addition to, or instead of, those illustrated in FIG. 3, and/or may include more than one of any or all of the illustrated elements, processes and devices.

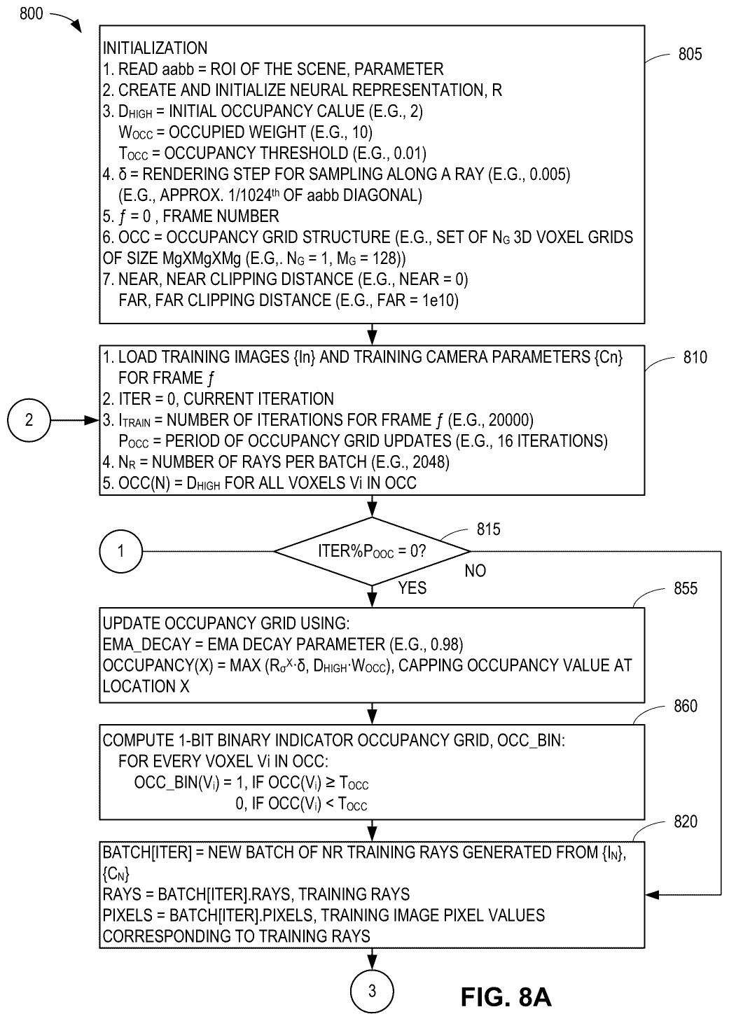

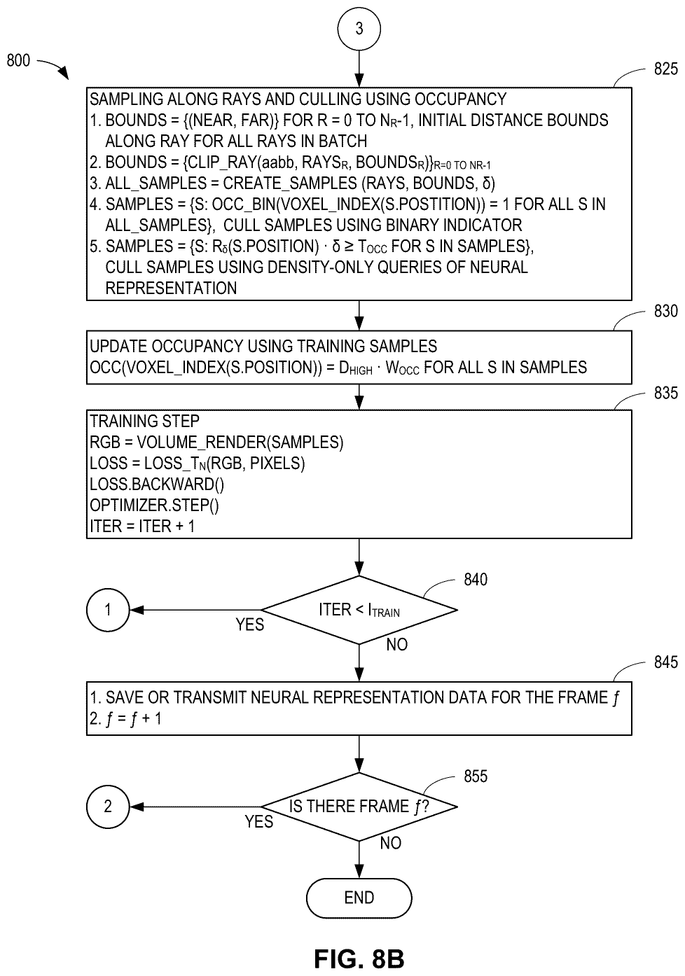

Flowchart(s) representative of example machine readable instructions, which may be executed by programmable circuitry to implement and/or instantiate the neural representation training circuit 300 of FIG. 3 and/or representative of example operations which may be performed by programmable circuitry to implement and/or instantiate the neural representation training circuit 300 of FIG. 3, are shown in FIGS. 7 and 8A-8B. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7 and 8A-8B, many other methods of implementing the example neural representation training circuit 300 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7 and 8A-8B may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to implement the neural representation training circuit 300 of FIG. 3. The example machine-readable instructions and/or the example operations 700 of FIG. 7 begin at block 705, at which the neural network training circuitry 305 of the neural representation training circuit 300 initializes parameters to be used to train the neural network 200 to generate neural representations (e.g., NeRFs) of frames of a neural video (e.g., an INV). At block 710, the neural network training circuitry 305 loads training data from the training data storage 325 for a current video frame for which the neural network 200 is to be trained.

At block 715, the occupancy grid generation circuitry 315 of the neural representation training circuit 300 initializes the values of the respective voxels 615 of the occupancy grid 600 for the current frame to the same initial value (e.g., Dhigh). At block 720, the occupancy grid generation circuitry 315 initializes the occupancy flags for the respective voxels 615 of the occupancy grid 600 for the current frame to an asserted value (e.g., logic-1) to indicate the voxels are occupied.

At block 725, the neural network training circuitry 305 obtains a current batch of training rays 605 for a current batch of training data selected from the training data loaded at block 710. At block 730, the optical density query circuitry 310 of the neural representation training circuit 300 queries the neural network 200 for optical density values at location sample points 620 along the current batch of training rays 605, as described above. At block 735, the occupancy grid generation circuitry 315 updates the values of the voxels 615 of the occupancy grid 600 based on the optical density values at the location sample points 620 along the current batch of training rays 605, as described above. For example, the occupancy grid generation circuitry 315 may compare the optical density values to a density threshold and identify those location sample points 620 having optical density values that satisfy (e.g., meet or exceed) the density threshold. The occupancy grid generation circuitry 315 may set the values of the voxels 615 corresponding to those location sample points 620 to a same, constant value (e.g., Dhigh). In some examples, the occupancy grid generation circuitry 315 also applies a decay factor to the voxels 615 of the occupancy grid 600 to cause the values of those voxels that are not occupied with geometry to reduce over time to a low value (e.g., to approach 0 or a value less than an occupancy threshold).

At block 740, the neural network training circuitry 305 trains the neural network 200 based on the current batch of training rays, the current batch of training data and the current occupancy grid 600. At block 745, the occupancy grid generation circuitry 315 determines whether it is time to update the occupancy flags for the voxels 615 of the occupancy grid 600 (e.g., by determining whether a number of training iterations corresponding to a grid update period have elapsed). If so, at block 750, the occupancy grid generation circuitry 315 updates the occupancy flags for the voxels 615 of the occupancy grid 600 based on the current values of the voxels 615, as described above. For example, the occupancy grid generation circuitry 315 may compare the current values of the voxels 615 of the occupancy grid 600 to an occupancy threshold. In some examples, the occupancy grid generation circuitry 315 sets the occupancy flag for a given voxel 615 of the occupancy grid 600 to an asserted value (e.g., logical 1) if that voxel's value satisfies (e.g., meets or exceeds) the occupancy threshold, and sets the sets the occupancy flag for the given voxel 615 to a de-asserted value (e.g., logical 0) if that voxel's value does not satisfy (e.g., is less than) the occupancy threshold.

At block 755, the neural network training circuitry 305 determines whether there are additional training data batches to be used to train the neural network 200 for the current video frame. If so, processing returns to block 725 and blocks subsequent thereto to allow the neural representation training circuit 300 to perform another training iteration for the current video frame. However, if there are no additional training data batches for the current video frame, at block 760 the neural network training circuitry 305 determines whether there are additional video frames for which the neural network 200 is to be trained. If so, processing returns to block 705 and blocks subsequent thereto to allow the neural representation training circuit 300 to train the neural network 200 to generate a neural representation (e.g., a NeRF) for the next video frame. Otherwise, the example machine-readable instructions and/or the example operations 700 end.

FIGS. 8A-8B collectively are a flowchart representative of second example machine readable instructions and/or example operations 800 that may be executed, instantiated, and/or performed by programmable circuitry to implement the neural representation training circuit 300 of FIG. 3. The example machine-readable instructions and/or the example operations 800 of FIGS. 8A-8B begin at block 805 of FIG. 8A, at which the neural network training circuitry 305 of the neural representation training circuit 300 initializes parameters to be used to train the neural network 200 to generate neural representations (e.g., NeRFs) of frames of a neural video (e.g., an INV). For example, the neural network training circuitry 305 sets an initial occupancy value (e.g., D_{HIGH}), an occupancy weight (e.g., W_{OCC}) and an occupancy threshold (e.g., T_{OCC}) to be used to generate and update the occupancy grid 600 for a given video frame. The neural network training circuitry 305 also initializes a rendering step size (e.g., δ) to be used to generate sample points 620 along training rays 605, which will be used to query the neural network 200 for optical density values for use in generating and updating the occupancy grid 600 for the given video frame.

At block 810, the neural network training circuitry 305 loads training data (e.g., training images and camera parameters) from the training data storage 325 to be used to train the neural network 200 for the current video frame (e.g., ƒ). The neural network training circuitry 305 also sets the number of training iterations to be performed for the current video frame (e.g., I_{TRAIN}), the number of training rays in a given training batch (e.g., N_{R}) and the period of occupancy grid updates (e.g., P_{OCC}). At block 810, the occupancy grid generation circuitry 315 of the neural representation training circuit 300 initializes the values of the respective voxels 615 of the occupancy grid 600 for the current frame to the same initial value (e.g., D_{HIGH}), which correspond to initializing all voxels 615 of the occupancy grid 600 to indicate they are occupied. The occupancy grid generation circuitry 315 also sets the occupancy flags for the voxels 615 of the occupancy grid 600 to indicate they are occupied (e.g., by asserting the occupancy flags to a logic-1 value).

At block 815, the occupancy grid generation circuitry 315 determines whether it is time to update the values and occupancy flags for the voxels 615 of the occupancy grid 600. If it is not time to update the occupancy grid 600, at block 820 the neural network training circuitry 305 gets a new batch of training rays 605 (e.g., RAYS) and training data (e.g., PIXELS) to be used to train the neural network 200 for the current video frame.

At block 825 of FIG. 8B, the optical density query circuitry 310 of the neural representation training circuit 300 generates the location sample points 620 (e.g., ALL_SAMPLES) along the training rays 605 of the current batch (e.g., by sampling along the rays based on the queries the neural network 200 based on the rendering step size, δ). The optical density query circuitry 310 then identifies those location sample points 620 (e.g., SAMPLES) associated with voxels 615 of the occupancy grid 600 that are occupied (e.g., that have asserted occupancy flags). The optical density query circuitry 310 then queries the neural network 200 for optical densities (e.g., R_{δ}) at those identified location sample points 620.

At block 825, the occupancy grid generation circuitry 315 further identifies those location sample points 620 associated with optical densities that satisfy (e.g., meet or exceed) occupancy threshold (e.g., T_{OCC}). At block 830, the occupancy grid generation circuitry 315 sets the values of the voxels 615 of the occupancy grid 600 corresponding to those identified location sample points 620 to a same, constant value (e.g., D_{HIGH}*W_{OCC}).

At block 835, the neural network training circuitry 305 trains the neural network 200 based on the culled location sample points 620 of the training rays 605 that were both associated with occupied voxels 615 of the occupancy grid 600 and that had optical densities that satisfied the occupancy threshold. At block 840, the neural network training circuitry 305 determines whether there are additional training data batches to be used to train the neural network 200 for the current video frame. If so, processing returns to block 815 and blocks subsequent thereto to allow the neural representation training circuit 300 to perform another training iteration for the current video frame. However, if there are no additional training data batches for the current video frame, the neural network training circuitry 305 outputs the trained neural network parameters (e.g., trained weights of the neural network 200) and the final occupancy grid 600 as the neural representation (e.g., NeRF) for the current video frame.

At block 850, the neural network training circuitry 305 determines whether there are additional video frames for which the neural network 200 is to be trained. If so, processing returns to block 810 and blocks subsequent thereto to allow the neural representation training circuit 300 to train the neural network 200 to generate a neural representation (e.g., a NeRF) for the next video frame. Otherwise, the example machine-readable instructions and/or the example operations 800 end.

Returning to block 815 of FIG. 8A, if the occupancy grid generation circuitry 315 determines that it is time to update the values and occupancy flags for the voxels 615 of the occupancy grid 600, processing proceeds to block 855. At block 855, the occupancy grid generation circuitry 315 updates the values of the voxels 615 of the occupancy grid based on an EMA decay factor. At block 860, the occupancy grid generation circuitry 315 updates the occupancy flags for the voxels 615 of the occupancy grid 600 based on the current values of the voxels 615. For example, the occupancy grid generation circuitry 315 compares the current values of the voxels 615 of the occupancy grid 600 to the occupancy threshold (e.g., T_{OCC}). In the illustrated example, the occupancy grid generation circuitry 315 sets the occupancy flag for a given voxel 615 of the occupancy grid 600 to an asserted value (e.g., logical 1) if that voxel's value satisfies (e.g., meets or exceeds) the occupancy threshold, and sets the sets the occupancy flag for the given voxel 615 to a de-asserted value (e.g., logical 0) if that voxel's value does not satisfy (e.g., is less than) the occupancy threshold.

FIG. 9 is a block diagram of an example programmable circuitry platform 900 structured to execute and/or instantiate the example machine-readable instructions and/or the example operations of FIGS. 7 and 8A-8B to implement the neural representation training circuit 300 of FIG. 3. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the neural network training circuitry 305, the optical density query circuitry 310, the occupancy grid generation circuitry 315, the example occupancy grid storage 320 and/or, more generally, the neural representation training circuit 300. In some examples, the 912 also implements the neural network 200.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916. In some examples, the volatile memory 914 implements the training data storage 325.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, one or more of the mass storage discs or devices 928 implement the training data storage 325.

The machine readable instructions 932, which may be implemented by the machine readable instructions of FIGS. 7 and 8A-8B, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 7 and 8A-8B to effectively instantiate the circuitry of FIG. 3 as logic circuits to perform operations corresponding to those machine readable instructions. In some such examples, the circuitry of FIG. 3 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7 and 8A-8B.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 7 and 8A-8B but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7 and 8A-8B. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7 and 8A-8B. As such, the FPGA circuitry 1100 may be configured and/or structured to effectively instantiate some or all of the operations/functions corresponding to the machine readable instructions of the flowchart(s) of FIGS. 7 and 8A-8B as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 7 and 8A-8B faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 7 and 8A-8B and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 7 and 8A-8B to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 7 and 8A-8B, and/or an ASIC may be configured and/or structured to perform third operation(s)/function(s) corresponding to a third portion of the machine readable instructions represented by the flowcharts of FIGS. 7 and 8A-8B.

It should be understood that some or all of the circuitry of FIG. 3 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 3 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

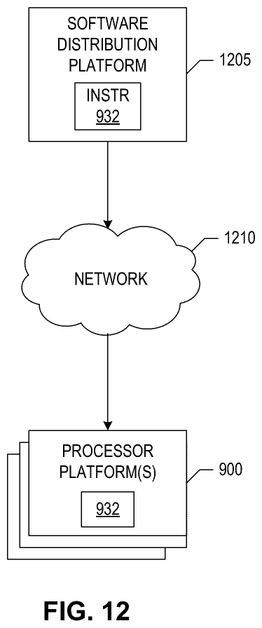

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 7 and 8A-8B, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 7 and 8A-8B, may be downloaded to the example programmable circuitry platform 900, which is to execute the machine readable instructions 932 to implement the neural representation training circuit 300. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement occupancy grids for neural radiance fields. Disclosed systems, apparatus, articles of manufacture, and methods improve the efficiency of using a computing device by using density data from training ray marching, instead of random sampling, to ensure geometry of a scene is accurately detected when generating an occupancy grid for a frame of the scene. Disclosed systems, apparatus, articles of manufacture, and methods also update the values of the occupancy grid voxels based on a fixed, pre-defined number, rather than the optical density values themselves as in prior techniques, which avoids the need for atomic operations when updating the grid voxels. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus to generate an occupancy grid for a neural representation of a video frame, the apparatus comprising interface circuitry, computer readable instructions, and at least one processor circuit to be programmed by the computer readable instructions to query a neural network for an optical density at a sample point along a training ray, the training ray associated with training the neural network to provide the neural representation of the video frame, and generate the occupancy grid for the video frame based on the optical density at the sample point along the training ray, the occupancy grid including voxels to indicate whether respective portions of a three-dimensional (3D) volume associated with the neural representation are occupied with geometry.

Example 2 includes the apparatus of example 1, wherein to generate the occupancy grid, one or more of the at least one processor circuit is to update a first one of the voxels based on the optical density at the sample point along the training ray, the first one of the voxels corresponding to a portion of the 3D volume including the sample point.

Example 3 includes the apparatus of example 1 or example 2, wherein one or more of the at least one processor circuit is to update the first one of the voxels based on comparison of the optical density at the sample point along the training ray to a threshold.

Example 4 includes the apparatus of any one of examples 1 to 3, wherein the training ray is a first training ray, the sample point is a first sample point, and one or more of the at least one processor circuit is to query the neural network for optical densities at sample points along a plurality of training rays, the plurality of training rays associated with a training iteration of the neural network, the plurality of training rays including the first training ray, the sample points including the first sample point, identify ones of the voxels of the occupancy grid associated with ones of the optical densities that satisfy a threshold, and set values of the ones of the voxels to a same value.

Example 5 includes the apparatus of any one of examples 1 to 4, wherein the voxels of the occupancy grid include values and flags, the values of the voxels are based on optical densities associated with respective training ray sample points included in the portions of the 3D volume associated respectively with the voxels, and the flags are set to indicate whether the portions of the 3D volume associated respectively with the voxels are occupied with geometry.

Example 6 includes the apparatus of any one of examples 1 to 5, wherein one or more of the at least one processor circuit is to set the flags of the voxels based on comparisons of the values of the voxels to a threshold.

Example 7 includes the apparatus of any one of examples 1 to 6, wherein one or more of the at least one processor circuit is to update the values of the voxels of the occupancy grid in successive training iterations associated with the video frame based on a decay value and updated optical densities returned by the neural network for updated sample points of updated training rays associated with the successive training iterations, and update the flags of the voxels of the occupancy grid at an interval corresponding to a number of training iterations.

Example 8 includes the apparatus of any one of examples 1 to 7, wherein one or more of the at least one processor circuit is to train the neural network based on the occupancy grid, the training rays, and training images corresponding respectively to different camera views associated with the video frame.

Example 9 includes at least one non-transitory computer readable medium comprising computer readable instructions to cause at least one processor circuity to at least query a neural network for an optical density at a sample point along a training ray, the training ray associated with training the neural network to provide a neural representation of a video frame, and generate an occupancy grid for the video frame based on the optical density at the sample point along the training ray, the occupancy grid including voxels to indicate whether respective portions of a three-dimensional (3D) volume associated with the neural representation are occupied with geometry.

Example 10 includes the at least one non-transitory computer readable medium of example 9, wherein to generate the occupancy grid, the computer readable instructions are to cause one or more of the at least one processor circuit to update a first one of the voxels based on the optical density at the sample point along the training ray, the first one of the voxels corresponding to a portion of the 3D volume including the sample point.

Example 11 includes the at least one non-transitory computer readable medium of example 9 or example 10, wherein the computer readable instructions are to cause one or more of the at least one processor circuit to update the first one of the voxels based on comparison of the optical density at the sample point along the training ray to a threshold.

Example 12 includes the at least one non-transitory computer readable medium of any one of examples 9 to 11, wherein the training ray is a first training ray, the sample point is a first sample point, and the computer readable instructions are to cause one or more of the at least one processor circuit to query the neural network for optical densities at sample points along a plurality of training rays, the plurality of training rays associated with a training iteration of the neural network, the plurality of training rays including the first training ray, the sample points including the first sample point, identify ones of the voxels of the occupancy grid associated with ones of the optical densities that satisfy a threshold, and set values of the ones of the voxels to a same value.

Example 13 includes the at least one non-transitory computer readable medium of any one of examples 9 to 12, wherein the voxels of the occupancy grid include values and flags, the values of the voxels are based on optical densities associated with respective training ray sample points included in the portions of the 3D volume associated respectively with the voxels, and the flags are set to indicate whether the portions of the 3D volume associated respectively with the voxels are occupied with geometry.

Example 14 includes the at least one non-transitory computer readable medium of any one of examples 9 to 13, wherein the computer readable instructions are to cause one or more of the at least one processor circuit to set the flags of the voxels based on comparisons of the values of the voxels to a threshold, update the values of the voxels of the occupancy grid in successive training iterations associated with the video frame based on a decay value and updated optical densities returned by the neural network for updated sample points of updated training rays associated with the successive training iterations, and update the flags of the voxels of the occupancy grid at an interval corresponding to a number of training iterations.

Example 15 includes a method to generate an occupancy grid for a neural representation of a video frame, the method comprising querying a neural network for an optical density at a sample point along a training ray, the training ray associated with training the neural network to provide the neural representation of the video frame, and generating, by at least one processor circuit programmed by at least one instruction, the occupancy grid for the video frame based on the optical density at the sample point along the training ray, the occupancy grid including voxels to indicate whether respective portions of a three-dimensional (3D) volume associated with the neural representation are occupied with geometry.

Example 16 includes the method of example 15, wherein the generating of the occupancy grid includes updating a first one of the voxels based on the optical density at the sample point along the training ray, the first one of the voxels corresponding to a portion of the 3D volume including the sample point.

Example 17 includes the method of example 15 or example 16, wherein the updating of the first one of the voxels is based on comparing the optical density at the sample point along the training ray to a threshold.

Example 18 includes the method of any one of examples 15 to 17, wherein the training ray is a first training ray, the sample point is a first sample point, and further including querying the neural network for optical densities at sample points along a plurality of training rays, the plurality of training rays associated with a training iteration of the neural network, the plurality of training rays including the first training ray, the sample points including the first sample point, identifying ones of the voxels of the occupancy grid associated with ones of the optical densities that satisfy a threshold, and setting values of the ones of the voxels to a same value.

Example 19 includes the method of any one of examples 15 to 18, wherein the voxels of the occupancy grid include values and flags, the values of the voxels are based on optical densities associated with respective training ray sample points included in the portions of the 3D volume associated respectively with the voxels, and the flags are set to indicate whether the portions of the 3D volume associated respectively with the voxels are occupied with geometry.

Example 20 includes the method of any one of examples 15 to 19, further including setting the flags of the voxels based on comparisons of the values of the voxels to a threshold, updating the values of the voxels of the occupancy grid in successive training iterations associated with the video frame based on a decay value and updated optical densities returned by the neural network for updated sample points of updated training rays associated with the successive training iterations, and updating the flags of the voxels of the occupancy grid at an interval corresponding to a number of training iterations.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture. and methods fairly falling within the scope of the claims of this patent.

What is claimed is:

1. An apparatus to generate an occupancy grid for a neural representation of a video frame, the apparatus comprising:
interface circuitry;
computer readable instructions; and
at least one processor circuit to be programmed by the computer readable instructions to:
query a neural network for an optical density at a sample point along a training ray, the training ray associated with training the neural network to provide the neural representation of the video frame; and
generate the occupancy grid for the video frame based on the optical density at the sample point along the training ray, the occupancy grid including voxels to indicate whether respective portions of a three-dimensional (3D) volume associated with the neural representation are occupied with geometry.

2. The apparatus of claim 1, wherein to generate the occupancy grid, one or more of the at least one processor circuit is to update a first one of the voxels based on the optical density at the sample point along the training ray, the first one of the voxels corresponding to a portion of the 3D volume including the sample point.

3. The apparatus of claim 2, wherein one or more of the at least one processor circuit is to update the first one of the voxels based on comparison of the optical density at the sample point along the training ray to a threshold.

4. The apparatus of claim 1, wherein the training ray is a first training ray, the sample point is a first sample point, and one or more of the at least one processor circuit is to:
query the neural network for optical densities at sample points along a plurality of training rays, the plurality of training rays associated with a training iteration of the neural network, the plurality of training rays including the first training ray, the sample points including the first sample point;
identify ones of the voxels of the occupancy grid associated with ones of the optical densities that satisfy a threshold; and
set values of the ones of the voxels to a same value.

5. The apparatus of claim 1, wherein the voxels of the occupancy grid include values and flags, the values of the voxels are based on optical densities associated with respective training ray sample points included in the portions of the 3D volume associated respectively with the voxels, and the flags are set to indicate whether the portions of the 3D volume associated respectively with the voxels are occupied with geometry.

6. The apparatus of claim 5, wherein one or more of the at least one processor circuit is to set the flags of the voxels based on comparisons of the values of the voxels to a threshold.

7. The apparatus of claim 6, wherein one or more of the at least one processor circuit is to:
update the values of the voxels of the occupancy grid in successive training iterations associated with the video frame based on a decay value and updated optical densities returned by the neural network for updated sample points of updated training rays associated with the successive training iterations; and
update the flags of the voxels of the occupancy grid at an interval corresponding to a number of training iterations.

8. The apparatus of claim 1, wherein one or more of the at least one processor circuit is to train the neural network based on the occupancy grid, the training rays, and training images corresponding respectively to different camera views associated with the video frame.

9. At least one non-transitory computer readable medium comprising computer readable instructions to cause at least one processor circuity to at least:
query a neural network for an optical density at a sample point along a training ray, the training ray associated with training the neural network to provide a neural representation of a video frame; and
generate an occupancy grid for the video frame based on the optical density at the sample point along the training ray, the occupancy grid including voxels to indicate whether respective portions of a three-dimensional (3D) volume associated with the neural representation are occupied with geometry.

10. The at least one non-transitory computer readable medium of claim 9, wherein to generate the occupancy grid, the computer readable instructions are to cause one or more of the at least one processor circuit to update a first one of the voxels based on the optical density at the sample point along the training ray, the first one of the voxels corresponding to a portion of the 3D volume including the sample point.

11. The at least one non-transitory computer readable medium of claim 10, wherein the computer readable instructions are to cause one or more of the at least one processor circuit to update the first one of the voxels based on comparison of the optical density at the sample point along the training ray to a threshold.

12. The at least one non-transitory computer readable medium of claim 9, wherein the training ray is a first training ray, the sample point is a first sample point, and the computer readable instructions are to cause one or more of the at least one processor circuit to:
query the neural network for optical densities at sample points along a plurality of training rays, the plurality of training rays associated with a training iteration of the neural network, the plurality of training rays including the first training ray, the sample points including the first sample point;
identify ones of the voxels of the occupancy grid associated with ones of the optical densities that satisfy a threshold; and
set values of the ones of the voxels to a same value.

13. The at least one non-transitory computer readable medium of claim 9, wherein the voxels of the occupancy grid include values and flags, the values of the voxels are based on optical densities associated with respective training ray sample points included in the portions of the 3D volume associated respectively with the voxels, and the flags are set to indicate whether the portions of the 3D volume associated respectively with the voxels are occupied with geometry.

14. The at least one non-transitory computer readable medium of claim 13, wherein the computer readable instructions are to cause one or more of the at least one processor circuit to:
set the flags of the voxels based on comparisons of the values of the voxels to a threshold;
update the values of the voxels of the occupancy grid in successive training iterations associated with the video frame based on a decay value and updated optical densities returned by the neural network for updated sample points of updated training rays associated with the successive training iterations; and
update the flags of the voxels of the occupancy grid at an interval corresponding to a number of training iterations.

15. A method to generate an occupancy grid for a neural representation of a video frame, the method comprising:
querying a neural network for an optical density at a sample point along a training ray, the training ray associated with training the neural network to provide the neural representation of the video frame; and
generating, by at least one processor circuit programmed by at least one instruction, the occupancy grid for the video frame based on the optical density at the sample point along the training ray, the occupancy grid including voxels to indicate whether respective portions of a three-dimensional (3D) volume associated with the neural representation are occupied with geometry.

16. The method of claim 15, wherein the generating of the occupancy grid includes updating a first one of the voxels based on the optical density at the sample point along the training ray, the first one of the voxels corresponding to a portion of the 3D volume including the sample point.

17. The method of claim 16, wherein the updating of the first one of the voxels is based on comparing the optical density at the sample point along the training ray to a threshold.

18. The method of claim 15, wherein the training ray is a first training ray, the sample point is a first sample point, and further including:
querying the neural network for optical densities at sample points along a plurality of training rays, the plurality of training rays associated with a training iteration of the neural network, the plurality of training rays including the first training ray, the sample points including the first sample point;
identifying ones of the voxels of the occupancy grid associated with ones of the optical densities that satisfy a threshold; and
setting values of the ones of the voxels to a same value.

19. The method of claim 15, wherein the voxels of the occupancy grid include values and flags, the values of the voxels are based on optical densities associated with respective training ray sample points included in the portions of the 3D volume associated respectively with the voxels, and the flags are set to indicate whether the portions of the 3D volume associated respectively with the voxels are occupied with geometry.

20. The method of claim 19, further including:
setting the flags of the voxels based on comparisons of the values of the voxels to a threshold;
updating the values of the voxels of the occupancy grid in successive training iterations associated with the video frame based on a decay value and updated optical densities returned by the neural network for updated sample points of updated training rays associated with the successive training iterations; and
updating the flags of the voxels of the occupancy grid at an interval corresponding to a number of training iterations.
